(19) United States
(12) Patent Application Publication
(10) Pub. No.: US 2004/0188355 A1
(43) Pub. Date: Sep. 30, 2004

(54) Method for separating low HLB contaminants from an aqueous dispersion of a high HLB oil

(76) Inventor: Hal Alper, Flowery Branch, GA (US)

Correspondence Address: KLAUBER & JACKSON, 411 HACKENSACK AVENUE, HACKENSACK, NJ, 07601

(21) Appl. No.: 10/643,582

(22) Filed: Aug. 19, 2003

Related U.S. Application Data
(60) Provisional application No. 60/405,551, filed on Aug. 23, 2002.

(51) Int. Cl. C02F 1/28

(52) U.S. Cl. 210/690

(57) ABSTRACT

A method for separating a more hydrophobic grease or oil contaminant from a less hydrophobic aqueous coolant/lubricant emulsion in which the contaminant has accumulated and in which it is itself emulsified. The contaminated coolant/lubricant is passed through a fluid pervious filtration media which has been infused with an absorption composition which is a homogeneous thermal reaction product of an oil component selected from the group consisting of glycerides, fatty acids, alkenes, and alkynes, and a methacrylate or acrylate polymer component. The contaminant is immobilized at the media and preferentially retained at the filter; and the purified filtrate having passed through the filtration media is collected for further use.

### RELATED APPLICATION

This application claims priority from U.S. provisional patent application 60/405,551 filed Aug. 23, 2002.

### FIELD OF INVENTION

This invention relates generally to methods and apparatus for separating and removing low HLB oily contaminants from aqueous systems, and more specifically relates to methods and filtration devices for removing such undesired contaminants from aqueous emulsions of high HLB oils and the like.

### BACKGROUND OF INVENTION

Numerous compositions in commercial use employ a highly water soluble oil dispersed in an aqueous phase. Drilling fluids and certain metalworking fluids (“MWFs”) are examples of such compositions. For purposes of the present specification these compositions will be collectively referred to herein as “aqueous coolant/lubricants”. Synthetic drilling fluids (or “drilling muds”) are thus basically an emulsion containing synthetic oils as the continuous phase, and brine as the discontinuous phase. The synthetic oils include linear or isomerized C₁₆/C₁₈ alpha-olefins or esters. MWFs are also known as coolants, cutting oils, lubricants and machining fluids. They are used in such metalworking processes as turning, grinding, boring, drawing, rolling etc. The MWFS combine the cooling properties of water with the lubricating properties of oil. The oils used in the MWFs of interest herein are highly water soluble and the MWFs usually include water soluble functional additives such as fatty acids or phosphate esters. All of these highly water soluble components have a high HLB and readily form aqueous dispersions with the water phase.

During commercial use the aforementioned aqueous coolant/lubricant compositions can become contaminated with oily low HLB substances, such as greases, coating oils or conventional bearing lubricants, which contaminants have themselves become emulsified in the coolant/lubricant. The resulting admixture can as a result become unusable, and may simply have to be disgarded. If the low HLB contaminants could be separated from the mix in an efficient manner, the desirable starting composition (the “high HLB dispersion”) could be recycled for its primary purpose.

### SUMMARY OF INVENTION

Now in accordance with the present invention, it has been found that the compositions disclosed in the present inventor's U.S. Pat. Nos. 5,437,793; 5,698,139; 5,837,146; and 5,961,823 (all of which disclosures are hereby incorporated by reference) have extremely strong affinities for the aforementioned contaminants, while having a much weaker affinity for the higher HLB, water soluble oils which are used in the high HLB dispersion; and that when the high HLB dispersion containing these low HLB contaminants is passed through filtration media incorporating these inventive compositions, the oily low HLB (more hydrophobic) contaminants are immobilized at the media, as a result of which concentration levels of the contaminants in the high HLB (less hydrophobic) dispersion filtrate may be reduced to very low values, in some instances below detectable limits in a single pass. Use of the invention thus enables ready removal from the primary less hydrophobic coolant/lubricant emulsion of the more hydrophobic low HLB oils, greases and the like, with the purified high HLB dispersion being susceptible to recycling as an MWF, a drilling mud, coolant, etc.

In accordance with the present invention, the contaminated high HLB coolant/lubricant emulsion is passed through one or more filters incorporating the principles of the invention. Unexpectedly the filtration process of the invention is so highly selective that the high HLB dispersion can in many instances pass virtually in its entirety through the filter. This couples with a further aspect of the invention, according to which changes in the pressure drop across the filter as a function of duration of use of the filter are exceedingly small, rendering the process not only highly effective, but also very economical in terms of need for servicing and/or filter replacement. This low change in pressure drop aspect of the filters used in the present invention is discussed in applicant's U.S. Pat. No. 6,475,393, the disclosure of which is incorporated herein by reference.

In accordance with the invention the HLB of the more hydrophobic contaminant being removed is always lower than the HLB of the less hydrophobic coolant/lubricant. The HLB of the contaminant is generally in the range of 1 to 8, but can be as high as 10 where multiple passes through the filter are used. In order to assure good efficacy with but a single filter pass, the HLB of the contaminant is preferably in the range of 1 to 6, and still more preferably is in the range of 1 to 4. Generally the molecular weight of a removed contaminant is higher than the molecular weight of the coolant/lubricant.

Filter configurations incorporating the above described compositions (hereinafter referred to as “absorbent compositions”) may be based on various water permeable substrates, such as shredded, spun or otherwise configured polypropylene or shredded or spun cellulose, which substrates are infused or otherwise treated with the absorbent compositions, which are then cured. These substrates may then be packed or otherwise disposed in a cartridge or canister filter; or can be formed into cured and infused bag filters which can be emplaced in canisters through which the contaminated bilgewater is flowed. Similarly the said absorbent compositions can be incorporated into or upon other filtering substrates and media, such as paper, including compressed pulp materials, particulate porous foamed plastics, mineral particulates such as perlite and vermiculite, and particulate, fibrous or porous ceramic or porous (e.g. sintered) metal substrates and media.

### DESCRIPTION OF PREFERRED EMBODIMENTS

It should be appreciated that the use herein of the term “absorbent composition” is one of convenience for identifying the compositions of my aforementioned patents and patent applications. The specific mechanism by which the contaminants are removed from the primary composition by conjunctive use of the “absorbent compositions” is not completely understood, and could include attachment and/or fixation of such contaminants by mechanisms which technically involve various physical and/or chemical interactions. The term “absorbent” as used herein is intended to encompass all of these possible mechanisms.

The absorbent composition disclosed in the first of my aforementioned patents, i.e. U.S. Pat. No. 5,437,793, is characterized therein as a coagulant product which comprises a glyceride such as linseed oil reacted with a polymer such as poly (isobutyl methacrylate) which is then diluted with a solvent, such as 2,2,4-trimethyl-1,3-pentanediol monoisobutyrate. The composition formed by the thermal reaction of the linseed oil with the isobutyl methacrylate polymer is a soft resinous product which, when diluted with a solvent, results in a mixture that in the teaching of the said patent can be sprayed onto an oil spill or otherwise introduced to the oil spill to coagulate the oil. Additionally, however, and as disclosed in my further U.S. Pat. No. 5,698,139 patent and copending applications above cited, further experimentation has led to the discovery of additional absorbent compositions produced from polymers and a variety of natural animal and vegetable oils, fatty acids, alkenes and alkynes, which absorbent compositions are all utilizable in the filters and filtration processes of the present invention. More generally these latter compositions are the thermal reaction product of a polymer component with an oil component selected from the group consisting of glycerides, fatty acids, alkenes and alkynes. The reaction conditions can be adjusted to provide a “first endpoint” product or a “second endpoint” product. Preferred compositions are disclosed which comprise the thermal reaction products of methacrylate polymers with a glyceride derived from a variety of natural animal and vegetable oils, or the thermal reaction products of methacrylate polymers with a fatty acid or alkene or alkyne containing from about 8-24 carbon atoms. The combination of a methacrylate polymer component with any of these oil components can provide either a first or second endpoint product, depending upon the reaction conditions. The term “first endpoint product” is used to describe the solubility product of the reaction which is a cooperative structure held together by many reinforcing, noncovalent interactions, including Van Der Waals attractive forces. The term “second endpoint product” is used to describe the product of the reaction which is the result of covalent bond formation between the polymer component and the oil component, as indicated by the change in molecular weight.

The absorbent composition is readily synthesized from a polymer component and an oil component selected from the group consisting of glycerides, fatty acids, alkenes and alkynes. In a preferred embodiment, the product is synthesized from an isobutyl methacrylate polymer, and the oil component is one derived from a natural oil, such as linseed oil or sunflower oil. Optionally, the composition is then diluted with a solvent, such as 2,2,4-trimethyl-1,3-pentanediol monoisobutyrate or acetone. The diluted composition can then be applied to a desired substrate for use as a filtration media pursuant to the present invention.

The polymer component of the absorbent composition is a synthetic polymer such as polymers derived from methacrylates. Preferably, the polymer is derived from methyl methacrylate, ethyl methacrylate, isobutyl methacrylate, or n-butyl methacrylate, or may be a copolymer containing a methacrylate polymer. Most preferably, the polymer is a poly(isobutyl methacrylate) polymer such as that obtainable from ICI Acrylics as ELVACITE® 2045, or a methacrylate/methacrylic acid copolymer such as ELVACITE® 2008 or 2043. However, it is anticipated that other equivalent polymers can be used to prepare equivalent compositions of the invention. Combinations of polymers can be used to advantage in the preparation of the absorbent compositions.

The test used to determine whether or not a polymer can be used in preparing the absorbent compositions of the present invention is to combine the polymer component in question with the oil component, as set forth herein, to see if the resultant combination forms a homogenous product after heating. Ideally, the polymer component percentage of the composition should range from about 15-75%, preferably 20-40%, or more preferably from about 25-35%, by weight.

In one embodiment of the absorbent composition, the oil component of the composition is a glyceride derived from oils of vegetable or animal origin. Vegetable oils are obtained by cold pressing the seeds of a plant to obtain the oil contained therein. Of the vegetable oils, drying oils such as sunflower, tung, linseed, and the like; and semi-drying oils, such as soybean and cottonseed oil, have been shown to be useful as the glyceride component of the invention. Animal oils, such as, for example, fish oil, tallow and lard can also be used as a glyceride component of the composition. It is anticipated that any drying oil or semi-drying oil will work in the composition. Generally, a drying oil is defined as a spreadable liquid that will react with oxygen to form a comparatively dry film. Optionally, combinations of two or more glycerides can be used as reactants with the polymer to provide absorbent compositions useful in the present invention.

In a preferred embodiment, the oil component of the absorbent composition is a glyceride derived from a drying oil, such as linseed oil, that can be obtained from Cargill, Inc. as Supreme Linseed Oil, or sunflower oil. The glyceride should comprise from about 25-85%, preferably about 60-80%, and most preferably, from about 65-75% of the coagulant composition. All percentages in this disclosure are by weight, unless otherwise stated.

Where the oil component of the composition is a fatty acid or alkene or alkyne utilized as the reactant with the polymer, it contains from about 8 to 24 carbon atoms, and preferably from about 10 to 22 carbon atoms. Such fatty acids, alkenes and alkynes are commercially available from many suppliers. Typical fatty acids include both saturated and unsaturated fatty acids, such as lauric acid [dodecanoic acid], linolenic acid, cis-5-dodecanoic acid, oleic acid, erucic acid [cis-docosanoic acid], 10-undecynoic acid, stearic acid, caprylic acid, caproic acid, capric acid [decanoic acid], palmitic acid, docosanoic acid, myristoleic acid [cis-9-tetradecenoic acid], and linoleic acid. Typical alkenes and alkynes contain at least one and preferably one or two degrees of unsaturation, and from about 8 to 24 carbon atoms, with 10-20 carbon atoms being preferred. Preferred alkenes and alkynes are those such as 1-decene, trans-5-decene, trans-7-tetradecene, 1,13-tetradecadiene, 1-tetradecene, 1-decyne, and 5,7-dodecadiyne.

The absorbent composition is a product with characteristics different from either of the starting materials or a simple mixture of the two starting materials, thus showing that a new composition is produced by the thermal reaction. Specifically, the oil/polymer absorbent compositions pass a clear pill test after being heated at the elevated temperatures and do not separate into two parts upon being cooled but, rather form a homogenous, uniphase compound.

More specifically, the solvent can be selected from aliphatic hydrocarbons, aromatic hydrocarbons, alcohols, ketones, ethers, aldehydes, phenols, carboxylic acids, synthetic chemicals and naturally occurring substances.

The absorbent composition used in the present invention may be prepared by a thermal reaction process. The first step of the process involves heating the oil component (glyceride or fatty acid or alkene or alkyne) to approximately 235-350° F. at a rate of about 5° F. per minute with continuous stirring. Then, the polymer component, usually in powdered form, is slowly stirred into the heated oil component. Depending upon the particular reactants used, the oil component should range from about 25-85%, preferably about 65-80%, more preferably about 72-77%, and the polymer should range from about 1-50%, preferably about 20-40%, more preferably about 23-28%, of the coagulant composition. After this mixture has been mixed properly, the mixture should be heated to approximately 400-700° F., depending on the particular components utilized for the reaction, and the desired endpoint of the reaction. Typically, reaction temperatures below about 500° F. produce “first endpoint products” while temperatures above about 500° F. produce “second endpoint products” The mixture should be heated at that temperature until a clear pill test indicates that the reaction has reached its first end point, i.e., a drop of the reaction mixture when placed on a clear glass plate is clear. When a clear pill test indicates that the reaction has reached its first end-point, the mixture should be cooled to a temperature below 200° F., generally about 180° F. After cooling, the coagulant product can be diluted with a suitable solvent to form a more liquid product that is easier to handle and use. The temperature at which the solvent is added is not critical, but the solvent should be added at a temperature where the coagulant composition is still pliable and the solvent will not rapidly evaporate.

Two reactions appear to occur between the oil component and the polymer component based upon the temperature and time. The first endpoint of the reaction results in a rubbery viscoelastic, relatively soft product with a melting point in the range of 100° F. to 250° F. This first endpoint product is homogeneous and does not separate upon melting or dissolution. This reaction occurs at 350° F.-500° F. This is designated the “first endpoint product” (solubility product).

In the second reaction, the polymer undergoes complete or partial chain fission into discrete polymer free radicals at a temperature above about 500° F. At between 350° F. to 500° F., it is believed that partial chain fission of the polymer component (isobutylmethacrylate polymer has a m.w.=300,000 Daltons) occurs at the end of the chain or in the middle. This results in a lower molecular weight product. It is believed that there may also be a solubility reaction occurring (similar to Sn and Pb forming solder) within the ternary composition. The occurrence of a chemical reaction is confirmed, however, due to the change of molecular weight.

Reactions at above 500° F. and up to 900° F. maintained at temperature from 5 minutes to 20 hours, depending on activation energy of compositions, result in the second endpoint product. This reaction is visually observable by color, rheology, and specific heat change in the product [Note: For the first endpoint product the end of the reaction is observed by change in color and a rheology change and the cessation of solution outgassing. There is also a change in specific heat as measured by Differential Scanning Calorimetry]. The second endpoint product has a weight average molecular weight in the range of about 62,000 Daltons which is consistent with complete chain fission of the polymer, resulting in smaller free radicals which results in a lower molecular weight compound. The melting point of these products is usually above 300° F. if the oil component is highly unsaturated, which results in a solid product due to the formation of highly bonded three dimensional densely packed molecular matrix. If the oil component has a low degree of unsaturation, the resultant product is usually liquid, which is consistent with this type of reaction.

The oily component and the polymer component are reacted in a thermal reaction that does not appear to be sensitive to the atmosphere under which the reaction is carried out, i.e., whether it is an inert, oxidizing or reducing atmosphere. Absorbent compositions have been prepared by this reaction which range from soft to hard, and elastomeric to brittle in nature depending upon the ratio of the oil component to the polymer component and the choice of the polymer component and/or the oil component used. If the reaction mixture separates into two phases upon cooling it is not useful for the invention. In this manner, any polymer can be identified for use in the invention.

The mechanism of the thermal reaction remains to be elucidated. While not wishing to be bound by any theory in this regard the reaction appears to be a polymerization or phase transition reaction brought about by heat and which is stable at lower temperatures. It is hypothesized that the elevated temperatures create monomer free radicals of the polymers and copolymers which then crosslink with the unsaturated glyceride molecules. It is also hypothesized that perhaps a phase transition is occurring between the oil component and the polymer component. In an effort to determine what type of interaction or reaction is occurring between the oil component and the polymer component, thermal analysis of several of the absorbent compositions was conducted. The results indicate that a reaction is occurring between the oil component and the polymer.

Differential scanning calorimetry (DSC) was thus performed on several such compositions. DSC is a thermal analysis technique that measure the quantity of energy absorbed or evolved by a sample in calories as its temperature is changed. The sample and a reference material are heated at a programmed rate. At a transition point in the sample's heating, such as when it reaches a melting point, the sample requires more or less energy than the reference to heat. These points are indicated by the typical DSC readout.

Samples were taken at the beginning of the reaction procedure described earlier and at the end of the reaction. The DSC profile for the initial starting materials is dramatically different from the profile of the product. The initial profile showed two exothermic events when the DSC analysis is carried out from 40-280° C., one event occurring at about 100° C. and the other at about 217° C. In the DSC profile of the reaction product, however, there was only one exothermic event, occurring at about 261° C. The samples were taken at initial and final points during the reaction and allowed to cool to room temperature before being subjected to the DSC.

In the instance of a further reaction, DSC's of the starting materials and final product were obtained. Again, the DSC curves generated show that two thermal events occurred for the “just mixed” reactants while only one thermal event occurred for the final product. Thus, the DSCs indicated that the occurrence of a reaction or phase transformation. Similar evidence obtained from IR spectra analysis also confirms that the absorbent compositions used in the invention are distinct products from the reactants used to prepare the absorbent compositions.

### EXAMPLE 1

In order to prepare a filter substrate for use with the invention, an infusion solution is prepared from a suitable solvent and the absorbent composition. In this example a solution was prepared from 90 w/w 99.9% acetone and 10 w/w absorbent composition which is the reaction product of 31% isobutyl methacrylate, 31% ELVACITE 2045, and 66% linseed oil. The absorbent composition is added to a closed explosion-proof mixer with the acetone and mixed for 12 hours or until the solution becomes homogeneous. The substrate in this Example was a nonwoven polypropylene, viz. the VERASPUN material of Yarorough & Co., Inc. of High Point N.C. This material has a weight of 1 oz./square ft. The substrate material was immersed in the infusion solution until saturated, then removed and excess liquid allowed to drip off. The material was then placed in a convection oven at 110 to 120° F. until acetone free. The material was then cured at room temperature for one week. The resulting material was then shredded and subsequently used in filter configurations.

### EXAMPLE 2

In order to demonstrate the sharply distinct affinities of the filter of Example I as a function of HLB for the dispersion being filtered, a series of emulsions of oils in aqueous phases were prepared and subjected to one or more passes through the filter. Results are shown in Table I below.

TABLE 1
Behavior of Dispersed

| Phase in Water | HLB Range | Filter Performance |
|---|---|---|
| Little or no Dispersability | 1-4 | Excellent |
| Poor Dispersion | 3-6 | Good to Excellent |
| Milky Dispersion After | 6-8 | Fair to Good - may require |
| Agitation | | recirculation |
| Stable Milky Dispersion | 8-10 | Fair - will require |
| | | recirculation |
| Translucent to Clear | >10-13 | Little Efficacy |
| Clear Solution | 13+ | |

### EXAMPLE 3

In this Example an aqueous MWF was used in metal machining operations. The MWF was based on a highly stable emulsion of a synthetic water soluble oil, along with additives including triethanol amine, amine borate, a mixture of fatty acids, phosphate esters, and soaps,. The metals had low HLB oils coating them and the tooling was lubricated with a low HLB oil for quality and reduced wear. The MWF became contaminated with the low HLB “tramp oils” which limited useful life of the MWF. By passing the contaminated MWF through a filter as in Example 2, the highly stable emulsion making up the MWF was recovered virtually intact as filtrate while the tramp oils were removed. This enabled further recycling and use of the purified MWF, and resulted in increased machining quality and reduced downtime.

While the present invention has been described in terms of specific embodiments thereof, it will be understood in view of the present disclosure, that numerous variations upon the invention are now enabled to those skilled in the art, which variations yet reside within the scope of the present teaching. Accordingly, the invention is to be broadly construed, and limited only by the scope and spirit of the claims now appended hereto.

1. A method for separating a more hydrophobic grease or oil contaminant from a less hydrophobic aqueous coolant/lubricant emulsion in which the contaminant has accumulated and in which it is itself emulsified, comprising:
passing the contaminated coolant/lubricant through a fluid pervious filtration media which has been infused with an absorption composition cured in situ at the infused media, said composition comprising a homogeneous thermal reaction product of an oil component selected from the group consisting of glycerides, fatty acids, alkenes, and alkynes, and a methacrylate or acrylate polymer component;
whereby said contaminant is immobilized at said media and preferentially retained at said filter; and
collecting the purified filtrate having passed through said filtration media.

2. A method in accordance with claim 1, wherein said coolant/lubricant is a metalworking fluid.

3. A method in accordance with claim 1, wherein said coolant/lubricant is a drilling fluid.

4. A method in accordance with claim 2, wherein said metalworking fluid comprises an emulsion of a highly water soluble synthetic oil dispersed in an aqueous phase, and wherein said emulsion of oilpasses substantially in its entirety through said filtrastion media to be collected as a purified filtrate.

5. A method in accordance with claim 4, wherein said metalworking fluid further comprises a highly emulsified fatty acid mixture and wherein the fatty acid mixture passes substantially in its entirety though said filtration media to be collected in said purified filtrate.

6. A method in accordance with claim 3, wherein said drilling fluid comprises an emulsion containing synthetic oil as the continuous phase and brine as the discontinuous phase.

7. A method in accordance with claim 6, wherein the synthetic oil includes linear or isomerized C₁₆/C₁₈ alpha-olefins or esters.

8. A method in accordance with claim 1, wherein the molecular weight of the contaminant is higher than the molecular weight of the coolant/lubricant.

9. A method in accordance with claim 1, wherein the HLB of the contaminant is lower than the HLB of the coolant/lubricant.

10. A method in accordance with claim 9, wherein the HLB of the contaminant is in the range of 1 to 8.

11. A method in accordance with claim 9, wherein the HLB of the contaminant is in the range of 1 to 6.

12. A method in accordance with claim 9, wherein the HLB of the contaminant is in the range of 1 to 4.
